(19) United States
(12) Patent Application Publication
(10) Pub. No.: US 2013/0004413 A1
(43) Pub. Date: Jan. 3, 2013

(54) OXIDES-BASED MATERIAL, DEVICE, AND PROCESS FOR HYDROGEN STORAGE

(75) Inventors: John J. Vajo, West Hills, CA (US); Ping Liu, Irvine, CA (US)

(73) Assignee: GM GLOBAL TECHNOLOGY OPERATIONS LLC, Detroit, MI (US)

(21) Appl. No.: 13/172,148

(22) Filed: Jun. 29, 2011

(51) Int. Cl. C01B 3/02; B65B 3/00; C01B 3/04

(52) U.S. Cl. 423/658.2; 423/648.1; 206/6

(57) ABSTRACT

A hydrogen storage material comprises an oxide and a hydride that can react with each other reversibly to produce hydrogen gas. A solid state hydrogen storage device and process of producing and storing hydrogen are also described.

### TECHNICAL FIELD

The field to which the disclosure generally relates includes hydrogen storage materials, devices and processes.

### BACKGROUND

Hydrogen can be stored in and produced from certain solid compounds that are able to undergo hydrogenation (i.e., taking in hydrogen) and dehydrogenation (i.e., releasing hydrogen) reactions reversibly. A solid material capable of generating hydrogen under appropriate temperature and pressure offers a low pressure and light-weight option as a fuel source for hydrogen fuel cells and other hydrogen-consuming devices.

Various compositions comprising different metal hydrides have been explored as reversible solid storage materials for hydrogen. Most of such materials have high dehydrogenation temperatures and/or un-desirable (typically too slow) kinetic rates of hydrogenation or dehydrogenation. It is usually observed that reversible metal hydrides become deactivated by certain impurities in the hydrogen environments. Any oxygen or sulfur in the environment, for example, can poison the surface of the hydride by reacting with it irreversibly to form stable oxide(s) or sulfides, therefore preventing hydrogenation and dehydrogenation reactions from taking place. As a result, metal hydrides used for reversible hydrogen storage must be of a high purity. Aluminum hydride AlH₃, for example, contains 10% hydrogen by weight and has a theoretical hydrogen density of 148 g/L, which is more than double the density of liquid H₂. Theoretically, based on thermodynamic considerations, AlH₃ will decompose to H₂ and Al at room temperature. However, the presence of an oxide surface layer in early experiments on AlH₃ synthesized without careful control of oxygen exhibited very slow H₂ evolution rates below 150° C. So far, oxides have generally been avoided for consideration as a reversible reactant in hydride-based hydrogen storage materials.

### SUMMARY OF EXEMPLARY EMBODIMENTS OF THE INVENTION

A hydrogen storage material comprises an oxide and a hydride. The oxide and hydride can react with each other reversibly to produce hydrogen gas.

A solid hydrogen storage device comprises a temperature control element, a pressure control element, and a mixture of an oxide and a hydride encased in a solid container. The oxide and hydride are selected such that they can react with each other reversibly to produce hydrogen and the enthalpy of the reaction is greater than zero.

A process for producing and storing hydrogen comprises: (a). combining an oxide with a hydride that is able to react with the oxide reversibly to produce hydrogen, where the enthalpy of the reaction is greater than zero; (b). causing the oxide and the hydride to react to produce hydrogen by raising the temperature above the equilibrium temperature of the reaction between the oxide and the hydride; and (c). supplying the hydrogen to a hydrogen-consuming device.

Other exemplary embodiments of the invention will become apparent from the detailed description provided hereinafter. It should be understood that the detailed description and specific examples, while disclosing exemplary embodiments of the invention, are intended for purposes of illustration only and are not intended to limit the scope of the invention.

### BRIEF DESCRIPTION OF THE DRAWINGS

FIG. 1 is a graph of weight percent desorbed hydrogen at varying temperatures and times according to an exemplary embodiment.

### DETAILED DESCRIPTION OF EXEMPLARY EMBODIMENTS

The following description of the embodiment(s) is merely exemplary in nature and is in no way intended to limit the invention, its application, or uses.

A hydrogen storage material comprises an oxide and a hydride. The oxide and hydride can react with each other reversibly. The forward reaction between the oxide and the hydride yields hydrogen gas and a reduced base comprising at least one of a metal, a reduced metal compound, and another metal oxide. The reverse reaction involves the reaction of hydrogen gas with the reduced base to yield the hydride and the oxide. Therefore, the forward reaction occurs during the dehydrogenation process where hydrogen is produced and liberated from the hydrogen storage material. The hydrogen generated during the dehydrogenation process may be supplied to a hydrogen-consuming device such as a hydrogen fuel cell or an internal combustion engine. The reverse reaction occurs during the hydrogenation process where hydrogen (typically in the form of a pressurized hydrogen gas) is provided to the reduce base of the hydrogen storage material and the reverse reaction converts the hydrogen gas and the reduce base into the solid hydride and oxide. The hydrogen storage material in the chemical form of the hydride and the oxide is herein referred to as the hydrogenated state of the material. The hydrogen storage material in the chemical form of reduced base is referred to as the dehydrogenated state of the material. The alternating process of hydrogenation and dehydrogenation is referred to as the hydrogen cycle.

The metal hydride may be selected from one of ionic, covalent, and complex hydrides. Ionic hydrides typically contain metal cations and negatively charged hydrogen ions. Examples of ionic hydrides include, but not limited to, lithium hydride, sodium hydride, calcium hydride, and potassium hydride. Due to its similar ionic nature and its ability to generate hydrogen, alkaline metal amides, which may also contain positively charged hydrogen ions, such as lithium amide, sodium amide, and potassium amide, are also included in the ionic hydride category in this application. In covalent hydrides, the metal-hydrogen bond is effected through a common electron pair between the metal and hydrogen atoms. Due to the electronegativity differences between hydrogen and the other element(s) in the hydride, the pair of common electrons may be polarized towards hydrogen, giving the hydride a partial ionic characteristic and a partial covalent characteristic. Examples of covalent hydrides include, but not limited to, beryllium hydride, magnesium hydride, aluminum hydride, zirconium hydride, silane, borane, ammonia borane, aminoboranes and germane. The complex hydrides are a large group of compounds in which hydrogen is combined in a fixed proportion with at least two other constituents, generally metal elements. A complex metal hydride can be represented by a typical chemical formula: M¹(M²Hₘ)ₙ, where M¹, M² are two different elements and n and m are numbers that correspond to the balance of electroneutrality of the molecule. M¹ may be one of Li, Na, K, Ca, Mg, Sr, La, and Ti, and M² may be one of Al, B, Ni, Fe and Ga. A complex hydride typically exhibits ionic bonding between a positive metal ion M¹ with molecular anions containing the hydride (M²Hₘ) portion. In such materials the hydrogen is bonded with significant covalent character to the second metal M² or metaloid atoms. Examples of complex hydrides include, but not limited to, lithium borohydride (LiBH₄), magnesium borohydride (Mg(BH₄)₂), calcium borohydride (Ca(BH₄)₂), potassium borohydride (KBH₄), aluminum borohydride (Al(BH₄)₃), beryllium borohydride (BeBH₄), lithium aluminum hydride (LiAlH₄), sodium aluminum hydride (NaAlH₄), magnesium aluminum hydride (Mg(AlH₄)₂), calcium aluminum hydride (Ca(AlH₄)₂), potassium aluminum hydride (KAlH₄), Mg₂FeH₆, TiFeH₂, LaNi₅H₆ and Mg₂NiH₄. Depending on the desired operating temperature, hydrogen pressure and kinetics of hydrogen cycle, hydrides with specific reactivity toward selected oxide(s) may be used. Non-limiting examples of hydrides with reversible reactivity toward oxides include LiH, LiBH₄, MgH₂, NaH, NaBH₄, KH, KBH₄, and CaH₂. The hydrogen storage material may comprise one or more of the metal hydrides described above.

The hydrogen storage material may comprise a mixture of at least two different hydrides having different dehydrogenation temperatures or thermal decomposition temperatures. Mixtures of two different hydrides can exhibit lower dehydrogenation temperatures and faster kinetic rates than each of its constituent hydrides. One such example is the mixture of MgH₂ and LiBH₄. When these hydrides are combined, the free energy is less than the respective free energy for hydrogen release of the individual compounds. Combination of a stable hydride and a destabilizing hydride is described in US Patent Application Publication numbers 20060013766 and 20060013753, which are incorporated herein by references in their entirety. Any combination of two or more of metal hydrides described above may be used to create a multiphase hydrogen storage material. In one embodiment, the hydrogen storage material comprises at least one stable hydride selected from the group consisting of lithium borohydride (LiBH₄), lithium aluminum hydride (LiAlH₄), sodium borohydride (NaBH₄), potassium borohydride (KBH₄), magnesium borohydride Mg(BH₄)₂, and any mixtures thereof. The hydrogen storage material may further comprise a simple hydride, such as an ionic or covalent metal hydride described above, as a destabilizing hydride to be mixed with a stable hydride.

Any oxide that can react reversibly with a hydride to produce hydrogen may be included in the hydrogen storage material. Suitable oxides may include both simple oxides and mixed oxides. Simple oxides are those oxides that comprise only oxygen and another element. Mixed oxides comprises oxygen and at least two different other elements. The oxide may comprise, for example, oxygen and at least one of the elements of B, Al, Si, P, Sc, Ti, V, Cr, Mn, Fe, Co, Ni, Cu, Zn, Ga, Ge, As, Y, Zr, Nb, Mo, Ru, La, Ce, Ta, and W. Examples of simple oxides may include, but not limited to, B₂O₃, Al₂O₃, SiO₂, P₂O₅, P₂O₃, TiO₂, TiO, Ti₂O₃, VO, V₂O₅, Cr₂O₃, MnO, MnO₂, FeO, Fe₂O₃, Fe₃O₄, CoO, NiO, Ni₂O, Cu₂O, CuO, ZnO, GaO, Ga₂O₃, GeO₂, GeO, As₂O₃, As₂O, Y₂O₃, Y₂O, ZrO₂, ZrO, Nb₂O₅, NbO₂, Nb₂O₃, NbO, MoO₂, MoO, RuO₂, RuO, La₂O₃, Ce₂O, Ta₂O₅, Ta₂O₃, WO, and WO₂. Examples of mixed oxides include, but not limited to, LiₓWO₂ (0≦x≦1), LiₓMoO₂ (0≦x≦1), (SiO₂)ₓ(Al₂O₃)₁₋ₓ (0≦x≦1), (TiO₂)ₓ(Al₂O₃)₁₋ₓ (0≦x≦1), (SiO₂)ₓ(B₂O₃)₁₋ₓ (0≦x≦1), (SiO₂)ₓ(Al₂O₃)₁₋ₓ (0≦x≦1), (SiO₂)ₓ(TiO₂)₁₋ₓ (0≦x≦1). The hydrogen storage material may comprise one or more of the oxides described above.

To form a hydrogen storage material, at least one oxide and at least one hydride are selected and combined together. The oxide and hydride are typically selected such that they can react reversibly to produce hydrogen. The forward reaction between the oxide and hydride generally has an enthalpy, ΔH, greater than zero. The forward reaction in a dehydrogenation process is generally endothermic (absorbing heat). The reverse reaction in a hydrogenation process is generally exothermic (generating heat). Under a certain temperature and pressure, the forward reaction and reverse reaction may reach equilibrium where Gibbs free energy, ΔG, approaches zero. For a given hydrogen pressure, the temperature at which the reaction reaches equilibrium is herein referred as the equilibrium temperature. The dehydrogenation process is typically carried out at a temperature above the equilibrium temperature of the reaction, while the hydrogenation process is typically carried out below the equilibrium temperature of the reaction. Since the hydrogenation process typically involves much higher hydrogen pressure than that of the dehydrogenation process, the equilibrium temperatures for hydrogenation and dehydrogenation can be quite different. Several non-limiting examples of chemical reactions between an oxide and a hydride are shown in reaction schemes 1 to 18. Computer software, HSC Chemistry for Windows (available from Outokumpu Research in Finland), is used to estimate the gravimetric hydrogen content and equilibrium temperature and enthalpy values. HSC chemistry for Windows consists of several computation modules and an extensive database containing a large collection of thermodynamics data such as enthalpy, entropy, and Gibbs free energy.

4LiH+TiO₂→2Li₂O+Ti+2H₂ [1]

In reaction scheme 1, the gravimetric hydrogen content is 3.6%, ΔH (20° C.)=55.5 kJ/mol-H₂, and equilibrium temperature at 1 bar hydrogen pressure, T (1 bar)=195° C.

LiBH₄+TiO₂→LiBO₂+Ti+2H₂ [2]

In reaction scheme 2, the gravimetric hydrogen content is 3.9%, and the equilibrium temperature at 1 bar hydrogen pressure, T (1 bar)=260° C.

3MgH₂+Al₂O₃→3MgO+2Al+3H₂ [3]

In reaction scheme 3, the gravimetric hydrogen content is 3.3%, and the equilibrium temperature at 1 bar hydrogen pressure, T (1 bar)=−15° C.

3LiBH₄+2Al₂O₃→3LiAlO₂+AlB₂+B+6H₂ [4]

In reaction scheme 4, the gravimetric hydrogen content is 4.5%, ΔH (20° C.)=34.3 kJ/mol-H₂, and equilibrium temperature at 1 bar hydrogen pressure, T (1 bar)=45° C.

4LiH+SiO₂→2Li₂O+Si+2H₂ [5]

In reaction scheme 5, the gravimetric hydrogen content is 4.4%, ΔH (20° C.)=37.5 kJ/mol-H₂, equilibrium temperature at 1 bar hydrogen pressure, T (1 bar)=50° C., and equilibrium temperature at 100 bar hydrogen pressure, T (100 bar)=225° C. In this example, LiH and SiO₂ may be combined at 4:1 stoichiometric molar ratio to be included in a hydrogen storage material in a hydrogen storage and supplying device. Hydrogen gas at about 1 bar working pressure can be produced by heating the hydrogen storage material to a temperature above 50° C. To recharge hydrogen in a hydrogenation process, a 100 bar pressurized hydrogen gas may be supplied to cause the reverse reaction at a temperature below 225° C.

LiBH₄+SiO₂→LiBO₂+Si+2H₂ [6]

In reaction scheme 6, the gravimetric hydrogen content is 4.9%, and the equilibrium temperature at 1 bar hydrogen pressure, T (1 bar)=110° C.

6LiH+B₂O₃→3Li₂O+2B+3H₂ [7]

In reaction scheme 7, the gravimetric hydrogen content is 5.1%, ΔH (20° C.)=7.6 kJ/mol-H₂, equilibrium temperature at 1 bar hydrogen pressure, T (1 bar)<−100° C.

6LiBH₄+B₂O₃→3Li₂O+8B+12H₂ [8]

In reaction scheme 8, the gravimetric hydrogen content is 12.0%, ΔH (20° C.)=51.9 kJ/mol-H₂, and equilibrium temperature at 1 bar hydrogen pressure, T (1 bar)=235° C.

3LiBH₄+2B₂O₃→3LiBO₂+4B+6H₂ [9]

In reaction scheme 9, the gravimetric hydrogen content is 5.9%, ΔH (20° C.)=kJ/mol-H₂, and equilibrium temperature at 1 bar hydrogen pressure, T (1 bar)<−100° C.

2LiH+VO→Li₂O+V+H₂ [10]

In reaction scheme 10, the gravimetric hydrogen content is 2.4%, ΔH (20° C.)=13.9 kJ/mol-H₂, and equilibrium temperature at 1 bar hydrogen pressure, T (1 bar)<−100° C.

LiBH₄+2VO→LiBO₂+2V+2H₂ [11]

In reaction scheme 11, the gravimetric hydrogen content is 2.5%, ΔH (20° C.)=16.4 kJ/mol-H₂, and equilibrium temperature at 1 bar hydrogen pressure, T (1 bar)<−100° C.

2LiBH₄+TiO→Li₂O+TiB₂+4H₂ [12]

In reaction scheme 12, the gravimetric hydrogen content is 7.5%, ΔH (20° C.)=11.5 kJ/mol-H₂, and equilibrium temperature at 1 bar hydrogen pressure, T (1 bar)<−100° C.

NaBH₄+2VO→NaBO₂+2V+2H₂ [13]

In reaction scheme 13, the gravimetric hydrogen content is 2.3%, ΔH (20° C.)=38.8 kJ/mol-H₂, equilibrium temperature at 1 bar hydrogen pressure, T (1 bar)=65° C.

3NaBH₄+2B₂O₃→3NaBO₂+4B+6H₂ [14]

In reaction scheme 14, the gravimetric hydrogen content is 4.7%, ΔH (20° C.)=32.5 kJ/mol-H₂, and equilibrium temperature at 1 bar hydrogen pressure, T (1 bar)=45° C.

LiBH₄+WO₂→2LiWO₂+B+2H₂ [15]

In reaction scheme 15, the gravimetric hydrogen content is about 1.6%.

xLiH+Li₍₁₋ₓ₎WO₂→LiWO₂+0.5xH₂ [16]

In reaction scheme 16, Li₍₁₋ₓ₎WO₂ (x is a real number between 0 and 1) is a mixed oxide. The cell potential, E, of the reaction at 20° C. is between 0 and −0.31V depending on the value of x. Cell potential of the reaction, E, is related to Gibbs free energy according to the following equation: ΔG=−nFE, where n is number of electron transfer in the reaction and F is Faraday's constant. When x=0.66, the above reaction can store and produce gravimetric hydrogen content of about 0.3%.

xLiBH₄+Li₍₁₋ₓ₎MoO₂→LiMoO₂+xB+2xH₂ [17]

In reaction scheme 17, Li₍₁₋ₓ₎MoO₂ (x is a real number between 0 and 1) is a mixed oxide. The cell potential, E, of the reaction at 20° C. is between 0 and −0.2V depending on the value of x. The gravimetric hydrogen content at x=0.5 is about 1.4%.

xLiBH₄+Li₍₁₋ₓ₎WO₂→LiWO₂+xB+2xH₂ [18]

In reaction scheme 18, Li₍₁₋ₓ₎WO₂ (x is a real number between 0 and 1) is a mixed oxide. The cell potential, E, of the reaction at 20° C. is between 0 and −0.31V depending on the value of x. The gravimetric hydrogen content at x=1 is about 1.6%.

As can be appreciated from the description above, one can produce a hydrogen storage material to meet a specific hydrogen cycle requirements (such as temperature and pressure requirements during hydrogenation and dehydrogenation) by selecting appropriate oxide and hydride combination.

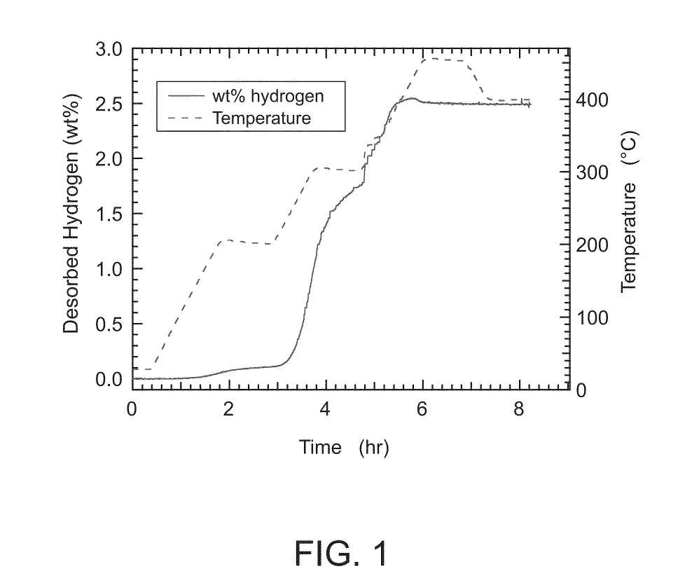

As an example, 0.347 grams of LiH (95%, Fluka), 0.655 grams SiO₂ (fused pieces, <4 mm, 99.99%, Aldrich), and 0.207 grams TiCl₃ (99.99%, Aldrich) were combined in an argon filled glove box with <1 ppm residual water and oxygen levels according to the stoichiometry of reaction scheme 5 above to create a mixture. The mixture was loaded into an 80 cm³ hard steel Fritsch milling vessel. Thirty Cr-steel milling balls, 7 mm in diameter were added and the mixture milled on a Fritsch P6 planetary mill for 1 hour at 400 rpm. After milling, 0.835 grams of the mixture was loaded into the sample vessel of a volumetric gas sorption system. Dehydrogenation of the mixture was monitored during heating at 2° C./min to 450° C. in several steps. The amount of hydrogen gas which evolved was quantified by measuring the system pressure and using calibrated system volumes to convert the pressure into moles of hydrogen. Using the sample mass, the moles of hydrogen were converted into weight percent hydrogen (wt %). The wt % hydrogen versus time during heating is shown in FIG. 1. FIG. 1 also shows the temperature. Upon heating to 450° C., dehydrogenation of about 2.5 wt % hydrogen occurred.

The hydrogen storage material may further comprise a catalyst that can enhance the rate of hydrogenation and/or dehydrogenation. Possible catalyst compositions, which may be used in concentrations from 0.1 to 10 atomic percent (based on the catalytic metal atom) include TiCl₃, TiH₂, TiHx (0.1≦x≦2), TiF₃, TiCl₂, TiCl₄, TiF₄, VCl₃. VF₃, VHx (0.1≦x≦2), NiCl₂, LaCl₃ and other similar transition metal compounds. Further examples of catalysts for the hydrogenation or dehydrogenation include halogen compounds or hydrides of scandium, chromium, manganese, iron, cobalt, copper, yttrium, zirconium, niobium, molybdenum, ruthenium, rhodium, palladium, cerium, neodymium, erbium, and platinum, as well as combinations of one or more of these metal elements in a chemical composition. The catalyst could be processed and incorporated into the hydrogen storage material by mechanical milling, precipitation from solution, dissolution-evaporation, crystallization, re-crystallization, vapor phase deposition, chemical transport, or sputter deposition process.

The hydrogen storage material may also comprise a hydride destabilizing agent that can lower the dehydrogenation temperature and/or the rate of dehydrogenation of a hydride. Examples of hydride destabilizing agent, include, but not limited to, silica, silicone, aluminum, copper, nanoparticle of inorganic materials, and magnesium compounds. Nanoparticle of inorganic materials may include nanoparticles of oxides, hydroxides, halides, silicates, carbon, nitrides and metals. Magnesium compounds may include magnesium halide (iodide, bromide, chloride and fluoride), and magnesium boride.

The oxide and hydride, along with other optional components of the hydrogen storage material may be combined using various mixing and/or synthesizing processes. Exemplary processes may include, but not limited to, ball-milling, mechanochemical processing, planetary milling, vibro-milling, vapor phase deposition, dissolution-precipitation, dissolution-evaporation, solution-crystallization, melt mixing, re-crystallization, solid state synthesis and/or sputtering deposition processes. The combination or mixing process may involve simple physical mixing, crystallization or chemical reactions to form a multiphase material with a desired size for each of the phases. The combination/mixing process may also involve diffusion of one chemical component from one phase to another, and formation of molecular solutions or alloys. The oxide and hydride may be combined and/or mixed in a stoichiometric molar ratio according to the reaction between them. The hydrogen storage material containing the oxide and the hydride may be high-energy ball milled for at least one hour in a Fritsch Pulversette 6 planetary mill at 400 rpm. The average particle diameter of the compound(s) remaining in the mill typically range from approximately 5 micrometers to about 15 micrometers. Optionally and alternatively, the individual constituents may be individually milled, if necessary, and mixed, or milled and mixed at the same time. Typical milling parameters using, for example, a Fritsch P6 planetary mill include: 400 rpm, 1 hour milling time, 80 cm³ hardened steel vessel, thirty 7 mm diameter Cr-steel balls, and 1.2 gram total sample mass. Where dry milling and mixing is not preferred for a combination of constituents, other practices such as solution-based methods (such as dissolution-precipitation, dissolution-evaporation, and solution-crystallization), or approaches based upon direct synthesis of nanoscale (1-100 nm) particles may be used to combine different components for improved reaction kinetics. To avoid unwanted agglomeration of nanoparticles during hydrogen cycles, it is possible to support individual particles in an inert matrix support or scaffold.

As appreciated by one of ordinary skills in the art, the hydrogen storage material may initially comprise the dehydrogenated products (such as the reduced base) or mixture, and may be subsequently hydrogenated, thereby cyclically releasing and storing hydrogen in accordance with the present invention.

A solid hydrogen storage device may be manufactured by using the hydrogen storage material described above. The hydrogen storage material may be provided as a high surface area multiphase mixture. It can be loaded, for an example, into a microporous support structure (such as a porous aluminum foam structure) inside a solid container fitted with a temperature control element and a pressure control element. The temperature control element may further include any heating, cooling, temperature measuring and control modules known to an ordinary skill in the field. Electric heating element, heat exchangers containing heating/cooling fluids, for example, may be employed. The device is typically insulated and sealed to prevent leakage or contact with environmental hazards. The container may comprise a glass fiber and/or carbon fiber reinforced shell layer(s). The container may also include a sintered stainless steel filter to further support and contain the solid hydrogen storage material. The device has a filling port to allow inflow of pressurized hydrogen to hydrogenate the hydrogen storage material at an appropriate temperature and pressure. The device may also have an outlet port that can be connected to a hydrogen fuel cell, a hydrogen battery, a hydrogen combustion engine, or other hydrogen-consuming devices. The outlet may include a pressure and temperature regulator to provide a controlled outflow of hydrogen gas to an external hydrogen-consuming device. The heat generated from a hydrogen-consuming device may be used to heat up the hydrogen storage material to maintain a desired rate of dehydrogenation (or hydrogen gas release). The heat produced by the hydrogen-consuming device may be transferred to the hydrogen storage material through a heat exchanger coil, heat conductive elements or other heat transfer apparatus known to an ordinary skill in the field.

The hydrogen storage and supply device may be used in military, aerospace, automotive, commercial and consumer applications as stationary and mobile power sources, remote power source, low profile power source, primary and auxiliary fuel cell power supplies, and power source for combustion engines and consumer electronics.

The above description of embodiments of the invention is merely exemplary in nature and, thus, variations thereof are not to be regarded as a departure from the spirit and scope of the invention.

What is claimed is:

1. A hydrogen storage material comprising an oxide and a hydride that can react with each other reversibly to produce hydrogen gas.

2. A hydrogen storage material as set forth in claim 1, wherein said oxide and said hydride are present at about stoichiometric amounts relative to each other according the chemical reaction between said oxide and said hydride.

3. A hydrogen storage material as set forth in claim 2, wherein the equilibrium temperature of said reaction at 1 bar hydrogen pressure is less than about 260° C.

4. A hydrogen storage material as set forth in claim 2, wherein the equilibrium temperature of said reaction at 1 bar hydrogen pressure is less than about 195° C.

5. A hydrogen storage material as set forth in claim 2, wherein the equilibrium temperature of said reaction at 1 bar hydrogen pressure is less than about 50° C.

6. A hydrogen storage material as set forth in claim 1, wherein the reaction between said oxide and said hydride is an endothermic reaction and the enthalpy, ΔH, of said reaction at 25° C. is greater than zero.

7. A hydrogen storage material as set forth in claim 1, wherein said hydride is one of an ionic hydride, a covalent hydride, a complex hydride and any combination thereof.

8. A hydrogen storage material as set forth in claim 1, wherein said hydride comprises LiH, LiBH₄, MgH₂, NaH, NaBH₄, KH, KBH₄, CaH₂ or any combination thereof.

9. A hydrogen storage material as set forth in claim 1, wherein said oxide comprises an oxide of at least one of the elements B, Al, Si, P, Sc, Ti, V, Cr, Mn, Fe, Co, Ni, Cu, Zn, Ga, Ge, As, Y, Zr, Nb, Mo, Ru, La, Ce, Ta, and W.

10. A hydrogen storage material as set forth in claim 9, wherein said oxide is a simple oxide.

11. A hydrogen storage material as set forth in claim 9, wherein said oxide is a mixed oxide.

12. A hydrogen storage material as set forth in claim 9, wherein said oxide is one of TiO₂, TiO, Al₂O₃, SiO₂, B₂O₃, VO, LiₓWO₂ (0≦x≦1), WO₂, and LiₓMoO₂ (0≦x≦1).

13. A hydrogen storage material as set forth in claim 1, wherein said material has a gravimetric hydrogen content of at least 2.3% at its fully hydrogenated state.

14. A hydrogen storage material as set forth in claim 1, wherein said material has a gravimetric hydrogen content of at least 3.9% at its fully hydrogenated state.

15. A hydrogen storage material as set forth in claim 1, wherein said material has a gravimetric hydrogen content of at least 5.1% at its fully hydrogenated state.

16. A hydrogen storage material as set forth in claim 1, wherein said material has a gravimetric hydrogen content of at least 7.5% at its fully hydrogenated state.

17. A solid hydrogen storage device comprising a temperature control element, a pressure control element, and a mixture of an oxide and a hydride encased in a solid container; wherein said oxide and said hydride are selected such that they can react with each other reversibly to produce hydrogen and the enthalpy of the reaction is greater than zero.

18. A solid hydrogen storage device as set forth in claim 17, wherein said reaction can be caused to go either forward or reverse direction by controlling temperature and hydrogen pressure inside said container using said temperature control element and pressure control element.

19. A process for producing and storing hydrogen comprising: combining an oxide with a hydride that is able to react with said oxide reversibly to produce hydrogen, where the enthalpy of the reaction is greater than zero; causing said oxide and said hydride to react to produce hydrogen by raising the temperature above the equilibrium temperature of the reaction between said oxide and hydride; and supplying said hydrogen to a hydrogen-consuming device.

20. A process for producing and storing hydrogen as set forth in claim 19 further comprising reversing said reaction between said oxide and said hydride by providing hydrogen at an elevated pressure and maintaining said oxide and said hydride at a temperature below said equilibrium temperature of said reaction.

21. A process for producing and storing hydrogen as set forth in claim 19, wherein said oxide and said hydride are provided at about stoichiometric amounts relative to each other according to said reaction.

22. A process for producing and storing hydrogen as set forth in claim 19, wherein said hydride comprises LiH, LiBH₄, MgH₂, NaH, NaBH₄, KH, KBH₄, CaH₂ or any combination thereof, and said oxide comprises an oxide of at least one of the elements B, Al, Si, P, Sc, Ti, V, Cr, Mn, Fe, Co, Ni, Cu, Zn, Ga, Ge, As, Y, Zr, Nb, Mo, Ru, La, Ce, Ta, and W.
